(19) United States
(12) Patent Application Publication
(10) Pub. No.: US 2017/0009020 A1
(43) Pub. Date: Jan. 12, 2017

(54) POLYSILOXANES COMPRISING METHYLENE-BONDED POLAR GROUPS

(71) Applicant: WACKER CHEMIE AG, München (DE)

(72) Inventors: Frank ACHENBACH, Simbach (DE); Birgit PESCHANEL, Burghausen (DE); Michael STEPP, Ueberackern (AT)

(21) Appl. No.: 15/116,245

(22) PCT Filed: Jan. 29, 2015
(86) PCT No.: PCT/EP2015/051815

§ 371 Date: Aug. 3, 2016

(30) Foreign Application Priority Data
Feb. 3, 2014 (DE) 10 2014 201 883.8

(51) Int. Cl. C08G 77/18; H01G 9/00; H01G 9/07; C07F 7/18

(52) U.S. Cl. CPC C08G 77/18; C07F 7/1892; H01G 9/0032; H01G 9/07

(57) ABSTRACT

Organopolysiloxanes containing a large proportion of methylene-bonded polar groups have high relative permittivities, and are especially useful as thermally stable dielectrics. A methoxymethyl alkoxysilane starting material is easily synthesized, and can be incorporated into the polymers by conventional methods known in organosilicon chemistry.

### CROSS REFERENCE TO RELATED APPLICATIONS

This application is the U.S. National Phase of PCT Appln. No. PCT/EP2015/051815 filed Jan. 29, 2015, which claims priority to German Application No. 10 2014 201 883.8 filed Feb. 3, 2014, the disclosures of which are incorporated in their entirety by reference herein.

### BACKGROUND OF THE INVENTION

1. Field of the Invention

The invention relates to polysiloxanes having siloxane units containing halogen-free polar radicals bonded via methylene groups.

2. Description of the Related Art

Dielectric liquids play a major role in electrical applications. Advantageous features of such liquids for applications where there can be electrical discharges are high thermal stability in conjunction with non-combustibility.

Polydimethylsiloxanes (silicones) have particularly high thermal stability and non-combustibility (flashpoint>320° C.; self-ignition temperature about 500° C.), a low pour point (about −45° C.) and excellent insulating properties (volume resistivity>10¹⁴ Ω·cm; dielectric strength>30 kV/2.5 mm) and a low dielectric loss factor (tan δ<10⁻³). These properties predestine the silicones for applications in electronics and electrical engineering (for example use thereof as a transformer oil).

A further material property of great significance for numerous electrical applications is the permittivity. This is a measure of the penetrability of a material by electrical fields. If a dielectric material is exposed to an electrical field, polarization of the material (for example as a result of orientation of dipoles present) attenuates the electrical field applied. The attenuation of the field caused by the dielectric material is referred to as relative permittivity εᵣ (by contrast with the absolute permittivity ε₀ of a vacuum). The relative permittivity, which is characteristic of different substances, depends on further factors, for example the temperature and especially the frequency of the electrical field. Because of relaxation and absorption processes during the polarization of a dielectric, the relative permittivity is a function having generally complex values. Permittivity shall always be understood hereinafter to mean the real part of the complex relative permittivity.

It is generally advantageous when the insulation materials used in electronic and electrical engineering applications feature low permittivities, since dielectrics having high permittivity cause unwanted capacitative effects. These include, for example, the reactive power of electrical components, which is a current flow that does not form part of the active power and is ultimately associated with electrical losses (heating). For this reason, insulation materials used for cables, transformers and electronic components are preferably substances having low permittivity (εᵣ=2-3). These include, for example, the (nonpolar) hydrocarbons (polyethylene, paraffin, etc.) and the silicones.

Materials having high relative permittivity offer advantages when they are used as a dielectric in electrical capacitors. The capacitance of a plate capacitor, i.e. the amount of charge and hence electrical energy stored at a given voltage, depends essentially on three parameters: the electrode area, the separation of the electrodes, and the permittivity of the dielectric between the electrodes. In order to achieve a high capacitance, the electrodes are rolled up or arranged as a stack, for example in the form of thin metal foils (separated by pm-thin dielectrics). However, any increase in the area and reduction in the separation of the electrodes is subject to tight limits. An increase in the voltage applied to the capacitor is also possible only to a limited degree, since it is limited by the dielectric strength of the material used as dielectric. However, the capacitance can be increased further by the use of dielectrics having higher permittivity. For example, it would be possible to increase the capacitance of a metal-paper capacitor (coil of paper metallized on one side and non-metallized paper) by impregnating with a siloxane of high permittivity, or to reduce the component size with the same capacitance.

However, the permittivity of conventional silicones (polydimethylsiloxanes) is low (εᵣ=2.76). The problem addressed was therefore that of developing silicones having high permittivity without adversely affecting the above-detailed advantageous properties (dielectric strength, non-combustibility, etc.).

According to the prior art, an increase in the permittivity of silicones can be achieved by adding finely divided fillers having high permittivity thereto (e.g. titanium dioxide, calcium copper titanate, graphene, phthalocyanines, barium titanate: εᵣ=10³-10⁴). In this way, however, a distinct increase in permittivity is achieved only at high filler contents, while the dielectric strength and flowability are subject to adverse changes at the same time. For example, the impregnating of the paper of a paper capacitor is made considerably more difficult by the presence of fillers in the silicone oil. Because of the size distribution of the filler particles, moreover, the probability of inhomogeneities and defects in the layers of the dielectric that have a thickness of a few μm is drastically increased.

In addition, attempts have been made to increase the permittivity by preparing a blend with highly polarizable polymers (polythiophenes, polypyrroles, polyethers). A disadvantage here is the non-compatibility of these polymers with the silicones, which is manifested in a phase separation.

Polydiorganosiloxanes with polar functional groups have already been recognized as potentially suitable candidates. For example, DE 10 2010 046 343 discloses siloxane additives for raising the relative permittivity in (addition-crosslinking) silicone mixtures. The covalent binding of polar or polarizable groups (e.g. trifluoropropyl, nitrile or anilino groups) to the siloxane chain via radicals having a delocalized electron system (e.g. phenylene radical) does enable the production of homogeneous dielectrics having elevated permittivity, but is very complex in terms of production and leads to adverse rheological properties.

JP 49080599 shows that easily obtainable chloromethylmethylsiloxane units in linear siloxanes lead to a distinct rise in relative permittivity to up to 6.2 (50 Hz) with simultaneously high dielectric strength (41 kV at 2.5 mm). However, there are applications in which freedom from chlorine is desirable (for example for avoidance of release of HCl in the event of fire). Therefore, it would be very beneficial if chlorine-free polysiloxanes having comparable properties were to be found.

### SUMMARY OF THE INVENTION

The invention provides polysiloxanes of the general formula (1)

[A-SiR₂—O_{1/2}]ₐ[B-SiRO_{2/2}]_{b}[C—SiO_{3/2}]_{c}[SiO_{4/2}]_{d} (1)

where
A, B, C is R or —CR¹R²-X,
X is O—R^{o1}, S—R^{o2}, S(O)R^{o3}, SO₂—R^{o4}, CN, NO₂,
R¹, R² are each a hydrogen radical or C₁-C₁₈ hydrocarbyl radical,
R^{o1}, R^{o2}, R^{o3}, R^{o4} are each a C₁-C₁₈ hydrocarbyl radical,
R is a hydrogen radical or an R^{a}, R^{b}, R^{c} or R^{d} radical,
R^{a} is a C₁-C₁₈ hydrocarbyl radical,
R^{b} is a radical of the general formula (2)

-(Q^{b})ₘ-Y, (2)
R^{c} is a radical of the general formula (3)

-(Q^{c})_{y}(O)ₖSi(G)₃₋ₙR′ₙ and (3)
R^{d} is a radical of the general formula (4)

-(Q^{d})_{z}[O(CH₂)_{q1}]ₒ[OCH(CH₃)(CH₂)_{q2}]ₚ-Z (4)

and
a is at least 1
b is at least 11,
m, y, z have the values of 0 or 1,
Q^{b}, Q^{c}, Q^{d} are an unsubstituted or substituted divalent C₁⁻C₁₃ hydrocarbyl radical,
Y is a F, Cl, Br, I, CF₃, SH, OOC—R′ or OR′ radical,
R′ is hydrogen or an unsubstituted or substituted C₁-C₁₈ hydrocarbyl radical,
G is an R³—O—, R⁴—COO—, —O—N═CR⁵R⁶, —NR⁷R⁸ or —NR⁹CO—R¹⁰ radical,
R³ to R¹⁰ are each an R′ radical,
k has the values of 0 or 1,
n has the values of 0, 1, 2 or 3,
Z is an —O—R′ or —OOC—R′ radical,
q1 and q2 each independently have the values of 1, 2, 3 or 4 and
o and p are each independently 0-80,
   with the provisos
   that, when Y is a F, Br, I, SH radical, m has the value of 1 and, when Y is a Cl, OH, OR′, OOC—R′ radical, m has the value of 0,
   that o+p≧1,
   that 0.1%-100% of the A, B and C units are —CR¹R²—X,
   that a+b+c+d is 11-10000 and
   that c+d<0.2*(a+b+c+d).

### DETAILED DESCRIPTION OF THE PREFERRED EMBODIMENTS

It was surprising and unforeseeable that the siloxanes of the general formula (1) feature outstandingly high relative permittivity values and high dielectric strength (breakdown field strength). These colorless and homogeneous polysiloxanes of the general formula (1) are preparable in a simple and inexpensive manner from the corresponding silanes by established standard methods of silicone chemistry. By choosing the stoichiometry of the feedstocks, it is possible to vary chain lengths and mixing ratios as desired.

If the dipole moment of dimethyl ether (4.3*10⁻³⁰ Cm ¹⁾) is compared with that of chloromethane (6.3*10⁻³⁰ Cm ¹⁾), assuming analogous ratios in the respective Si-substituted representatives (H₃C—O—CH₃ compared to Si—CH₂—OCH₃ and H₃C—Cl compared to Si—CH₂—Cl), one should expect, for example, polysiloxanes having methoxymethyl radicals to have a much lower relative permittivity than those having chloromethyl radicals. It was therefore surprising and unforeseeable that it is possible through introduction of a polar radical in the alpha position to the silicon to achieve comparably high relative permittivities to those in the case of chloromethylsiloxanes. These polysiloxanes are preparable by established standard methods of silicone chemistry from silanes which, as well as the corresponding methylene-bonded polar groups, bear hydrolyzable radicals.

In the general formula (1), X is preferably O—R^{o1} and CN, especially O—R^{o1}.

Examples of C₁-C₁₈ hydrocarbyl radicals R¹, R², R^{o1}, R^{o2}, R^{o3}, R^{o4}, R^{a} and R′ are alkyl radicals such as the methyl, ethyl, n-propyl, isopropyl, n-butyl, 2-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical; cycloalkyl radicals such as cyclopentyl, cyclohexyl, 4-ethylcyclohexyl, cycloheptyl, norbornyl, and methylcyclohexyl radicals. Among the alkyl radicals, preference is given to C₁-C₆-alkyl radicals such as the methyl and ethyl radical, especially the methyl radical.

Preferably, R^{o1} is the methyl or ethyl radical, especially the methyl radical.

For R¹ and R², the hydrogen radical is preferred.

Examples of R¹, R², R^{o1}, R^{o2}, R^{o3}, R^{o4}, R^{a} and R′ are also alkenyl radicals, such as the vinyl, 2-propen-2-yl, allyl, 3-buten-1-yl, 5-hexen-1-yl, 10-undecen-1-yl, cycloalkenyl radicals, for example the 2-cyclohexenyl, 3-cyclohexenyl, cyclopentadienyl, and 2-(cyclohex-3-en-1-yl)ethyl radicals, aryl radicals such as the phenyl, biphenylyl or naphthyl radical; alkaryl radicals such as o-, m- or p-tolyl radicals and phenethyl radicals (2-phenylethyl, 1-phenylethyl radicals) and aralkyl radicals such as the benzyl radical.

Examples of substituted hydrocarbyl radicals as R′ radicals are halogenated hydrocarbons, such as the chloromethyl, 3-chloropropyl, 3-bromopropyl, 3,3,3-trifluoropropyl and 5,5,5,4,4,3,3-heptafluoropentyl radical, and the chlorophenyl, dichlorophenyl and trifluorotolyl radical.

Among the R^{o1}, R^{o2}, R^{o3} and R^{o4} radicals, preference is given to alkyl radicals and aryl radicals having 1-6 carbon atoms, especially the methyl, ethyl and phenyl radical.

R^{a} and R′ each preferably have 1 to 6 carbon atoms. Especially preferred are ethyl, phenyl, vinyl and methyl radicals.

R³ to R¹⁰ are preferably hydrogen, methyl or ethyl radicals.

Examples of Q^{b}, Q^{c}, Q^{d} are —CH₂—, CH₂—CH₂—, —CH₂—CH (CH₃)—, —CH₂—CH₂—CH₂—, —(CH₂)₄—, (CH₂)₆—, 1,2-phenylene, 1,3-phenylene, and 1,4-phenylene.

Preferably, n has a value of 0 or 1, especially 0.

Preferably, k has a value of 0 or 1, especially 0 when y=1, and 1 when y=0.

Preferably at least 30%, especially at least 60%, and not more than 100%, especially not more than 80%, of the A, B and C units are —CR¹R²—X.

Examples of R^{b} radicals are —OH, Cl—, —O—CH₃, —O—CH₂—CH₃, —CH₂—CH₂—CH₂—Cl, —CH₂—CH₂—CH₂—SH, —CH₂—CH₂—CF₃, —CH₂—CH₂—CH₂—OOC—CH═CH₂, —CH₂—CH₂—CH₂—OOC—CCH₃═CH₂ and —OOC—CH₃, where the —OH, —Cl, —O—CH₃, —O—CH₂—CH₃ and —OOC—CH₃ radicals are more preferably bonded to a siloxane end group (=unit in the general formula (1) with the index a).

Examples of R^{c} radicals are —O—Si(OCH₃)₃, —O—Si(OCH₃)₂CH₃, —O—Si(OCH₂CH₃)₃, —O—Si(OCH₂CH₃)₂CH₃, —O—Si(OOCCH₃)₂CH₃, —O—Si(OOCCH₃)₃, CH₂—CH₂—Si(OCH₃)₃, —CH₂—CH₂—Si(OCH₂CH₃)₃, and —O—Si(OCH₂CH₃)₂H, where oxygen-bridged radicals are more preferably bonded to a siloxane end group (=unit in the general formula (1) with the index a).

Examples of R^{d} radicals are CH₃O[CH₂CH₂O]₈—(CH₂)₃—, CH₃COO[CH₂CH₂O]₆—(CH₂)₃— and CH₃O[CH₂CH₂O]₁₂[CH₂CH (CH₃)O]₁₂(CH₂)₃—.

Preferably, a+b+c+d is at least 20, more preferably at least 50, most preferably least 100, and not more than 8000, more preferably not more than 1000, and most preferably not more than 5000.

Preferably, c+d<0.1·(a+b+c+d), especially c+d<0.05·(a+b+c+d).

Preferably, o and p are each independently 0-36, especially 2-12.

Preferably at least 50%, more preferably at least 70% and most preferably at least 80% of all R radicals are a methyl radical.

Preferably not more than 33%, more preferably not more than 10% and especially not more than 5% of the R radicals are an R^{b}, R^{c} or R^{d} radical.

Preferably, in the general formula (1),

B is a —CH₂—O—R^{o1} radical, especially the methoxymethyl radical,
C is an R^{a} or R^{b} radical, especially an R^{a} radical,
R is the hydrogen radical, the methyl radical or the vinyl radical, particular preference being given to the methyl radical, and especially at least one R radical in the general formula (1) is a hydrogen radical, a vinyl radical or an R^{c} radical.

Examples of polymers of the general formula (1) are:

[H₂C═CH—Si(CH₃)₂O_{1/2}]₂[CH₃O—CH₂—Si(CH₃)O]₅₈,
[H₂C═CH—Si(CH₃)₂O_{1/2}]₂[NC—CH₂—Si (CH₃)O]₇₇,
[HOSi(CH₃)₂O_{1/2}]₂[NC—CH₂—Si(CH₃)O]₇₃[Si(CH₃)₂O]₂₈,
[H₂C═CH—Si(CH₃)₂O_{1/2}]₂[NC—CH₂—Si(CH₃)O]₁₉₀[Si(CH₃)₂O]₂₇₇,
[H₂C═CH—Si(CH₃)₂O_{1/2}]₁[Si(CH₃)₃O_{1/2}]₁[CH₃O—CH₂—Si(CH₃)O]₉₃,
[HOSi(CH₃)₂O_{1/2}]₂[CH₃O—CH₂—Si(CH₃)O]₁₀₄,
[CH₃OSi(CH₃)₂O_{1/2}]₂[CH₃O—CH₂—Si(CH₃)O]₁₀₄,
[HOSi(CH₃)₂O_{1/2}]₂[CH₃O—CH₂—Si(CH₃)O]₈₂[Si(CH₃)₂O]₂₇
[H₂C═CH—Si(CH₃)₂O_{1/2}]₂[CH₃O—CH₂—Si(CH₃)O]₂₉₉[Si(CH₃)₂O]₂₀₆[H₂C═CH—Si(CH₃)O]₁₂
[Si(CH₃)₃O_{1/2}]₂[CH₃O—CH₂—Si(CH₃)O]₉₉[Si(CH₃)₂O]₂₉[(H₃CO)₃SiCH₂CH₂—Si(CH₃)O]₄
[HOSi(CH₃)₂O_{1/2}]₁[(H₃C)₃SiO_{1/2}]₃[CH₃O—CH₂—Si(CH₃)O]₁₁₀[Si(CH₃)₂O]₇₅
[H₃C(H₃CO)₂SiO_{1/2}]₂[CH₃O—CH₂—Si(CH₃)O]₁₀₄[Si(CH₃)₂O]₁₁₈
[H₃CH₂C(H₃COO)₂SiO_{1/2}]₂[CH₃O—CH₂—Si(CH₃)O]₅₀₈
[HO—Si(CH₃)₂O_{1/2}]₃[H₃C—SiO_{3/2}]₁[CH₃CH₂O—CH₂—Si (CH₃)O]₈₇[Si(CH₃)₂O]₂₉
[H₂C═CH—Si(CH₃)₂O_{1/2}]₂[HS—(CH₂)₃—Si(CH₃)O]₃[OH₃O—CH₂—Si(CH₃)O]₆₇[H₂C—CH—Si (CH₃)O]₆[Si(CH₃)₂O]₁₆
[H₂C═CH—Si(CH₃)₂O_{1/2}]₂[F₃C—(CH₂)₂—Si(CH₃)O]₃₃[C₆H₆S—CH(CH₃)—Si(CH₃)O]₁₅[Si(CH₃)₂O]₆₅
[H₂C═CHCOO—(CH₂)₃—Si(CH₃)₂O_{1/2}]₂[CH₃O—CH₂—Si(CH₃)O]₁₄[Si(CH₃)₂O]₃₄
[H—Si(OCH₂CH₃)₂O_{1/2}]₂[HS—(CH₂)₃—Si(CH₃)O]₂[C₆H₆O—CH₂—Si(CH₃)O]₁₄[H₂C—OH—Si(CH₃)O]₆[Si(CH₃)₂O]₁₁₆
[H₂C═CH—Si(OCH₂CH₃)₂O_{1/2}]₂[C₆H₅(CH₃)SiO]₃₅[CH₃O—CH₂—Si(CH₃)O]₁₇[Si(CH₃)₂O]₃₆
[H₂O═OH—Si(CH₃)₂O_{1/2}]₁[Si(CH₃)₃O_{1/2}]₁
[H₃CO—(CH₂CH₂O)₄—(CH₂)₃—Si(CH₃)O]₆[CH₃O—OH₂—Si(CH₃)O]₆₇[Si(CH₃)₂O]₁₂

The polysiloxanes of the general formula (1) are prepared by relevant methods known from the literature, for example by
co-hydrolysis of the respective chloro- or alkoxysilanes and subsequent condensation or
equilibration of siloxanes each containing different concentrations of desired siloxane units or
equilibration of siloxanes with alkoxy- or chlorosilanes and subsequent hydrolysis and condensation or
hydrosilylation of SiH-containing polysiloxanes.

The starting compounds are generally products that are commercially available or preparable inexpensively by literature methods. For example, dimethyldichlorosilane, vinyldimethylchlorosilane, vinylmethyldichlorosilane, methyldichlorosilane and trimethylchlorosilane are products obtainable on the industrial scale from the Müller-Rochow process. Chloromethyldimethylchlorosilane, chloromethylmethyldichlorosilane and chloromethyltrichlorosilane are preparable according to EP 1310501, by photochlorination of the corresponding methylchlorosilanes.

The invention also provides a process for preparing the particularly preferred starting compounds of the general formula (5)

R^{o1}O—CH₂—Si(OAlk)₍₃₋ₜ₎R^{a}ₜ (5)

where R^{o1} and R^{a} have the definition given above,
Alk is a linear or branched alkyl radical having 1-4 carbon atoms and
t=0, 1, 2 or 3, more preferably 0 or 1.
   Since a side reaction that can be observed is an exchange of the Si-bonded alkoxy groups for the alkoxide radicals, preference is given to using the alkoxides wherein the alkyl radical R^{o1} corresponds to the alkyl radical Alk in the chloromethylsilane used.

The process of the invention for preparing the compounds of the general formula (5) is effected by reacting the corresponding chloromethylalkylalkoxysilane of the general formula (6)

Cl—CH₂—Si(OAlk)₍₃₋ₜ₎R^{a}ₜ (6)

with a metal alkoxide in the presence of an inert solvent having a boiling point at least 20° C., more preferably at least 40° C. above the boiling point of the compound of the general formula (5), according to the following reaction equation:

1/v*)(R^{o1}O⁻)ᵥM^{v+}+Cl—CH₂—Si(OAlk)₍₃₋ₜ₎R^{a}ₜ--->R^{o1}O—CH₂Si(OAlk)₍₃₋ₜ₎R^{a}ₜ+1/v*Mv+Cl⁻ᵥ

where v is the charge of the metal M and is preferably 1, 2, 3 or 4 and

M is preferably an alkali metal or alkaline earth metal, more preferably an alkali metal, especially sodium or potassium. Preferred examples of compounds of the general formula (R^{o1}O⁻)ᵥM^{v+} are sodium methoxide, sodium ethoxide, potassium methoxide and potassium ethoxide, which are commercially available.

As well as the expected effect of simplified workup of the reaction mixture, especially avoidance of a filtration, it has been found that, surprisingly, use of a high-boiling inert solvent in the reaction can distinctly increase the yield and selectivity of the reaction compared to the prior art.

The process of the invention is characterized in that one molar equivalent of chloromethylalkoxysilane of the general formula (6) is reacted with one molar equivalent of R^{o1}O⁻ bound within a metal alkoxide of the general formula (R^{o1}O⁻)ᵥM^{v+} in an inert high-boiling nonpolar solvent, then, in order to avoid side reactions, any basic constituents present are scavenged by adding a chlorosilane and the target product is isolated directly from the mixture by fractional distillation. The solvent assures good stirrability of the salt-containing reaction mixture (suspension) during the reaction and distillation, and additionally the easy removal of the metal chloride formed by addition of water after the distillation and removal of the lower salt phase by simple phase separation.

Based on one molar equivalent of chloromethylalkoxysilane of the general formula (6), preferably at least 0.95/v and more preferably at least 1.0/v molar equivalent, and preferably not more than 1.2/v and more preferably not more than 1.05/v molar equivalents, of metal alkoxide (R^{o1}O⁻)ᵥM^{v+} are used; more particularly, 1.0/v molar equivalent is used, since excesses of alkoxide lead to unwanted yield-reducing side reactions, for example the cleavage of the Si—CH₂(Cl) bond and any excess of silane of the general formula (6) can be removed by distillation only with difficulty.

Preferably, the metal alkoxide of the general formula (R^{o1}O⁻)ᵥM^{v+} is initially charged as an alcoholic solution in the inert nonpolar solvent. Particular preference is given to using solutions of the metal alkoxide in the particular alcohol R^{o1}OH, which contain 10% to 40% by weight of alkoxide and are preferably commercially available.

Useful inert solvents include all nonpolar compounds which have minimal solubility in water and which do not enter into any unwanted reactions with the feedstocks and the products. Preferably, the solubility in water at 25° C. is not more than 10% by weight, more preferably not more than 1% by weight, more preferably not more than 0.1% by weight. Preferably, the solvent has a density of <1 g/mL; this facilitates phase separation, since the aqueous phase which is usually discarded can be removed easily as the lower phase. The upper phase consists of nonpolar inert solvent and can optionally be washed again with water. Residual amounts of water can easily be removed again from the inert solvent by distillation, optionally under reduced pressure, such that the solvent can be recovered apart from small losses and is available again in the reaction vessel for the next reaction—without decanting operations.

Examples of inert nonpolar solvents are alkanes and isoalkanes, and also aromatics and alkylaromatics, which may also be partly hydrogenated. It is also possible to use mixtures. The boiling points which have been standardized to 0.10 MPa are preferably at least 20° C., more preferably at least 40° C. above the boiling points of the target products. The amount thereof used is preferably at least 50 and more preferably at least 80 parts by weight, and preferably at most 200 and more preferably at most 150 parts by weight, based on 100 parts by weight of chloromethylalkoxysilane of the general formula (6) used.

Experience has shown that side reactions can be avoided when the metal alkoxide is initially charged in a mixture with the inert solvent and the chloromethylalkoxysilane is metered in. However, reversal of the metered addition or parallel metered addition of the reactants can offer advantages in the individual case, for example the latter variant when a continuous process is the aim. The reaction temperature is preferably at least 0° C., more preferably at least 20° C., and most preferably at least 30° C., and preferably at most 100° C., more preferably 80° C., and most preferably 50° C. If the alkoxide is used in the form of a solution in the corresponding alcohol, preference is given to distilling the excess alcohol off at standard pressure after the reaction/metered addition has ended. The substantially alcohol-free final reaction mixture is then admixed with a chlorosilane, preferably trimethylchlorosilane or dimethyldichlorosilane, in order to scavenge any unconverted alkoxide present, the latter leading to side reactions that reduce the yield of target product. Preferably not more than 20 mol %, more preferably not more than 10 mol % and especially not more than 5 mol % of chlorine, based on chloromethylalkoxysilane, is added in the form of the chlorosilane.

Subsequently, the target product is isolated, preferably by fractional distillation, optionally under reduced pressure. The alkoxysilane formed from the residual alkoxide and the added chlorosilane and the unreacted excess of the chlorosilane are preferably removed here together with the first fraction of the distillate. The distillation bottoms consists predominantly of the inert nonpolar solvent, the chloride of the metal from the metal alkoxide used and any high-boiling by-products (e.g. hydrolysis products) of the target product of the general formula (5). The nonpolar solvent is regenerated by adding the amount of water required to dissolve the salt and the secondary components, optionally while heating, and removing the aqueous phase. If any insoluble constituents that occur are disruptive, they can be washed out with water prior to distillation and removed with the water phase, or be removed from the organic phase by filtration.

Preferably, prior to distillation, alcohol R^{o1}—OH is added once again, in order to convert chlorine-Si bonds that are potentially present to alkoxy-Si bonds. In this way, it is possible to avoid side reactions during the distillation. Preferably at least 0.5 molar equivalent and more preferably at least 1 molar equivalent of alcohol R^{o1}—OH, based on chlorosilane used, is added.

Examples of compounds of the general formula (5) are: (CH₃O)₃Si—CH₂OCH₃, (CH₃CH₂O)₃Si—CH₂OCH₃, (CH₃CH₂O)₃Si—CH₂OCH₂CH₃, (CH₃O)₃Si—CH₂OCH₂CH₃, (CH₃O)₂(CH₃CH₂O)Si—CH₂OCH₂CH₃, ([CH₃]₂CHO)₃Si—CH₂OCH₃, ([CH₃]₂CHO)₃Si—CH₂OCH[CH₃]₂, (CH₃O)₂CH₃Si—CH₂OCH₃, (CH₃CH₂O)₂(CH₃)Si—CH₂OCH₃, (CH₃CH₂O)₂(CH₃)Si—CH₂OCH₂CH₃, ([CH₃]₂CHO)₂(H₃C)Si—CH₂OCH₃, ([CH₃]₂CHO)₂(H₃C)Si—CH₂OCH₂CH₃, (CH₃)₂(H₃CO)Si—CH₂OCH₃, (CH₃CH₂O) (CH₃)₂Si—CH₂OCH₃, (CH₃CH₂O) (CH₃)²Si—CH₂OCH₂CH₃,

All the above symbols in the above formulae are defined independently of one another. In all the formulae, the silicon atom is tetravalent.

In the examples which follow, unless stated otherwise in each case, all statements of amount and percentage are based on weight and all reactions are conducted at a pressure of 0.10 MPa (abs.).

The dielectric properties were measured with a DIANA measuring instrument (dielectric analyzer) from Lemke Diagnostics. The measurement cell was from Haefely Trench AG: Type 2903. The conditions in each case were room temperature, 50 Hz and 1000 V. The measurement of breakdown voltage was conducted in accordance with DIN 57370 or VDE 0370 with a Dieltest DTA 100 from Baur (electrode separation 2.5 mm±0.02 mm, figure reported=mean formed from 6 individual measurements).

### PREPARATION EXAMPLE 1

### Methoxymethylmethyldimethoxysilane

A nitrogen-inertized 2 L 5-neck round-bottom flask with paddle stirrer, dropping funnel, thermometer and a 40 cm column filled with random packings and having a distillation attachment is initially charged with 561.6 g of Hydroseal® G400H (hydrogen-treated middle distillate mineral oil from Total, boiling range 300-370° C.) and 672.8 g of 30% sodium methoxide solution (3.74 mol). While stirring, 590 g (3.74 mol) of chloromethyl-methyldimethoxysilane are metered in within 140 minutes. In the course of this, the temperature of the reaction mixture rises to 36° C. Within 15 minutes, the mixture is heated to reflux (71° C.). At a reflux ratio of not more than 3:1 (reflux volume: withdrawal volume), at a top temperature of 69° C., 522.6 g of methanol are distilled off within 150 minutes. The bottoms are cooled to 54° C., and 40.5 g (0.37 mol) of trimethylchlorosilane are added. The mixture is left to stir at 55° C. for 10 minutes and then fractionally distilled under reduced pressure through the column filled with random packings. The majority of 361.7 g (98.7 GC area%, 64% of theory) of target product is present in the fraction having a top temperature of 95° C. and a pressure of 300 hPa. The GC analyses of the first and final fractions show a yield totaling 92% of theory.

### PREPARATION EXAMPLE 2

### Methoxymethylmethylpolysiloxane

### (CH₃) (CH₃OCH₂)SiO_{2/2}:(CH₃)₃SiO_{1/2}=41:2

a) Hydrolysis of Methoxymethyldimethoxymethylsilane (see Preparation Example 1)

A nitrogen-inertized 1 L 5-neck round-bottom flask with paddle stirrer, thermometer, column head and dropping funnel is initially charged with 57.6 g (3.2 mol) of demineralized water. Through the dropping funnel, 480.6 g (3.2 mol) of methoxy-methyldimethyoxymethylsilane are metered in while stirring within 75 minutes. Over the course of the metered addition, the temperature of the mixture rises. By cooling with a water bath, the temperature is kept below 36° C. Reaction is allowed to continue at 25° C. for another 4 hours and then 201.7 g of a clear colorless liquid are distilled off under reduced pressure (1 hPa) at a bottoms temperature of not more than 65° C. The residue remaining is 333.4 g of a colorless liquid which, according to the ²⁹Si and ¹H NMR spectrum, has the following composition (=“hydrolyzate a)”):

86 mol % of a linear polysiloxane of the average formula:

[(OH₃OCH₂)(CH₃)SiO]₅₈[CH₃O(OH₃OOH₂)(CH₃)SiO_{1/2}]_{1.6}[HO(CH₃OCH₂)(CH₃)SiO_{1/2}]_{0.4}

14 mol % of cyclic siloxanes of the general formula

[(CH₃OCH₂)(CH₃)SiO]₄₋₇

b) Equilibration of the Hydrolyzate from a) with Hexamethyldisiloxane

In a nitrogen-inertized 500 mL 5-neck round-bottom flask with paddle stirrer, thermometer, column head and dropping funnel, at 25° C., 330.3 g (3.17 mol) of hydrolyzate a) are admixed with 8.58 g (0.05 mol) of hexamethyldisiloxane (=WACKER CHEMIE AG, AK 0.65) and 380 μL of a 10% solution of equilibration catalyst “PNC12” in ethyl acetate (as described in DE4317978, example 1) and the mixture is stirred at 90° C. for one hour. After cooling to 30° C., in order to deactivate the catalyst, 930 μL of a 25% aqueous ammonia solution are added. The mixture is stirred at 30° C. for 15 minutes and subsequently heated at 1 hPa to 200° C. until no further distillate passes over. The cloudy bottoms are filtered through a pressurized suction filter (Seitz® K250 filter). 286.7 g of a clear colorless polymer are isolated, which, according to the ²⁹Si and ¹H NMR spectrum, has the following average formula:

[(CH₃OCH₂)(CH₃)SiO]41[CH₃O(CH₃OCH₂)(CH₃)SiO_{1/2}]_{0.7}[(CH₃)₃SiO_{1/2}]_{1.3}

Dynamic viscosity: 160.4 mPas (25° C.), 85 (50° C.), 34.5 (100° C.)

Density: 1.0638 g/mL (20° C.), refractive index: 1.4267, thermal

conductivity: 0.169 W/(m*K) (23° C.)

Surface tension: 26.6 mN/m (20° C.)

Relative permittivity εᵣ: 9.6 (50 Hz/23° C.)

Dielectric loss factor: 1.67 (50 Hz/23° C.)

Breakdown voltage: 43 kV/mm

1.-8. (canceled)

9. A polysiloxane composition comprising a polysiloxane of a formula (1)
[A-SiR₂—O_{1/2}]ₐ[B-SiRO_{2/2}]_{b}[C—SiO_{3/2}]_{c}[SiO_{4/2}]_{d} (1)
where
A, B, C is R or —CR¹R²-X,
X is O—R^{o1}, s-R^{o2}, S(O)R^{o3}, SO₂—R^{o4}, CN, or NO₂,
R¹, R² are each a hydrogen radical or C₁-C₁₈ hydrocarbyl radical,
R^{o1}, R^{o2}, R^{o3}, R^{o4} are each a C₁-C₁₈ hydrocarbyl radical,
R is a hydrogen radical or an R^{a}, R^{b}, R^{c} or R^{d} radical,
R^{a} is a C₁-C₁₈ hydrocarbyl radical,
R^{b} is a radical of the general formula (2)
-(Q^{b})ₘ-Y (2)
R^{c} is a radical of the general formula (3)
-(Q^{c})_{y}(O)ₖSi(G)₃₋ₙR′ₙ, and (3)
R^{d} is a radical of the general formula (4)
-(Q^{d})_{z}[O(CH₂)_{q1}]ₒ[OCH(CH₃)(CH₂)_{q2}]ₚ-Z (4)
and
a is at least 1
b is at least 11,
m, y, z are each 0 or 1,
Q^{b}, Q^{c}, Q^{d} are an unsubstituted or substituted divalent C₁-C₁₈ hydrocarbyl radical,
Y is an F, Cl, Br, I, CF₃, SH, OOC—R′ or OR′ radical,
R′ is hydrogen or an unsubstituted or substituted C₁-C₁₈ hydrocarbyl radical,
G is an R³—O—, R⁴—COO—, —O—N═CR⁵R⁶, —NR⁷R⁸ or —NR⁹—CO—R¹⁰ radical,
R³ to R¹⁰ are each an R′ radical,
k is 0 or 1,
n is 0, 1, 2 or 3,
Z is an —O—R′ or —OOC—R′ radical,
q1 and q2 each independently are 1, 2, 3 or 4, and
o and p are each independently 0-80,
with the provisos
that, when Y is an F, Br, I, or SH radical, m is 1, and when Y is a Cl, OH, OR′, OOC—R′ radical,
m is 0,
o+p≧1,
30%-100% of the A, B and C units are —CR¹R²-X,
a+b+c+d is 11-10,000 and
c+d<0.2*(a+b+c+d).

10. A polysiloxane composition of claim 9, wherein X is an O—R^{o1} radical.

11. A polysiloxane composition of claim 9, wherein R¹ and R² are hydrogen radicals.

12. A polysiloxane composition of claim 10, wherein R¹ and R² are hydrogen radicals.

13. A polysiloxane composition of claim 9, wherein R is a C₁-C₁₈ hydrocarbyl radical.

14. A polysiloxane composition of claim 10, wherein R is a C₁-C₁₈ hydrocarbyl radical.

15. A polysiloxane composition of claim 11, wherein R is a C₁-C₁₈ hydrocarbyl radical.

16. A polysiloxane composition of claim 9, wherein at least 50% of all R radicals are methyl radicals.

17. A polysiloxane composition of claim 9, wherein c+d<0.05 ·(a+b+c+d).

18. In a capacitor employing a liquid dielectric, the improvement comprising employing as the dielectric a polysiloxane composition of claim 9.

19. A process for preparing a compound of the formula (5)
R^{o1}O—CH₂—Si(OAlk)₍₃₋ₜ₎R^{a}ₜ (5)
comprising:
reacting a chloromethylalkylalkoxysilane of the formula (6)
Cl—CH₂—Si(OAlk)₍₃₋ₜ₎R^{a}ₜ (6)
with a metal alkoxide (R^{o1}O⁻)ᵥM^{v+} in the presence of an inert alkane, isoalkane, aromatic, or alkylaromatic solvent optionally partly hydrogenated, or a mixture thereof, having a boiling point at least 20° C. above the boiling point of the compound of the formula (5), where
R^{o1} and R^{a} are a C₁-C₁₈ hydrocarbyl radical
Alk is a linear or branched alkyl radical having 1-4 carbon atoms,
t is 0, 1, 2 or 3 and
v is the charge of the metal M.

20. The process of claim 19, wherein, based on one molar equivalent of chloromethylalkoxysilane of the formula (6), 0.95/v to 1.2/v molar equivalents of metal alkoxide (R^{o1}O⁻)ᵥM^{v+} are used.
